(19) United States
(12) Patent Application Publication
(10) Pub. No.: US 2018/0120557 A1
(43) Pub. Date: May 3, 2018

(54) SCANNING DEVICE AND SCANNING METHOD

(71) Applicants: Robert Bosch GmbH, Stuttgart (DE); Koninklijke Philips N.V., Eindhoven (NL)

(72) Inventor: Gael Pilard, Wankheim (DE)

(21) Appl. No.: 15/571,992

(22) PCT Filed: May 9, 2016
(86) PCT No.: PCT/EP2016/060318

§ 371 Date: Nov. 6, 2017

(30) Foreign Application Priority Data
May 22, 2015 (DE) 10-2015-209 418.9

(51) Int. Cl. G02B 26/10; G02B 27/09; G01B 11/02; G01S 7/481; G01S 17/66; G02B 26/08; G02B 3/14

(52) U.S. Cl. CPC G02B 26/101; G02B 27/0916; G01B 11/026; G01S 7/4817; G02B 3/14; G01S 7/4814; G01S 17/66; G02B 26/0833; G02B 27/0955

(57) ABSTRACT

A scanning device, comprising a laser (1) for emitting a light beam (3); a collimator lens (2) with a settable focal length (f1) for focusing a light beam (3) emitted by the laser (1); and a micromirror (4) for modulating the light beam (3) emitted by the laser (1); wherein a light beam distance (L) from the laser (1) at which a beam radius (d) of the light beam (3) emitted by the laser (1) is at a minimum is settable by setting the focal length (f1) of the collimator lens (2).

The present invention relates to a scanning device and a corresponding scanning method.

### PRIOR ART

Micromirrors are micro-electromechanical systems (MEMS) that can be used to modulate light. Micromirrors have various uses, for example in projection displays, in 3D cameras, in laser marking and machining of materials, in object detection, in object measurement and velocity measurement or in fluorescence microscopy.

For example, a laser in combination with a collimator lens and a micromirror can be used to measure distances. The collimator lens here has a fixed focal length. However, in distance measurement, measurement is typically possible only if a beam radius of a light signal emitted by the laser is smaller than a specific value. Consequently, a measurement region of the device is limited in the case of a fixed arrangement of collimator lens and micromirror.

U.S. Pat. No. 8,947,784 B2 discloses a lens with a settable focal length, wherein the lens has chambers having liquids with different optical properties.

### DISCLOSURE OF THE INVENTION

The present invention discloses a scanning device having the features of patent claim 1 and a scanning method having the features of patent claim 6.

Accordingly, a scanning device is provided, comprising: a laser for emitting a light beam; a collimator lens with a settable focal length for focusing a light beam emitted by the laser, and a micromirror for modulating the light beam emitted by the laser; wherein a light beam distance from the laser at which a beam radius of the light beam emitted by the laser is at a minimum is settable by setting the focal length of the collimator lens.

In accordance with a further aspect, a scanning method is provided, comprising the steps of: detecting whether an object is located within a capturable distance region from a laser, in which a beam radius of a light beam emitted by the laser is less than a specified value, on the basis of the light beam reflected by the object; setting a light beam distance from the laser at which the beam radius of the light beam emitted by the laser is at a minimum by setting a focal length of a collimator lens, which is arranged downstream of the laser, if an object was detected.

Preferred developments are the subject matter of the respective dependent claims.

### ADVANTAGES OF THE INVENTION

The present invention provides a cost-effective scanning device which can be configured in a compact manner, wherein a large and adaptable measurement distance can be attained. In addition, it is possible by setting the focal length of the collimator lens to correct a lens error that has occurred due to the production process of the collimator lens. Due to the fact that, according to the present invention, a measurement distance of the scanning device is settable, the scanning device is universally usable and is not limited to a specific use. A further advantage is that a measurement distance is settable by setting the focal length of the collimator lens. In particular, objects or surfaces, the distances of which vary within a wide range, can also be measured using a single scanning device by adapting the measurement distance. In particular, distance determination, velocity determination or angular displacement determination of the object can here be performed precisely by the scanning device within a large distance region.

It is possible with the method in accordance with the invention to focus a scanning device on an object to be measured.

According to a further embodiment of the present device, the laser is a VCSEL. The use of a VCSEL in the scanning device is particularly suitable for distance measurement and can therefore be used for example for 2D mice.

In accordance with a further embodiment of the present device, the collimator lens comprises a liquid-crystal lens, an optofluidic lens, a polymer lens or a mechanically settable lens. With these lenses it is possible, due to various physical principles, to adjust a curvature of the lenses and thus a focal length of the lenses.

In accordance with a further embodiment of the present device, the device has a magnification lens for magnifying a scanning range of a region that is scanned by the laser. As a result, a scanning angle and thus also the size of the scannable region can additionally be enlarged. As a result, a breadth of the scannable region is additionally enlarged.

In accordance with a further embodiment of the present device, the magnification lens has a settable focal length, and the magnification of the scanning range of the region that is scanned by the laser is settable by setting the focal length of the magnification lens. Hereby, both the magnification of the magnification lens and the focal length of the collimator lens are settable, as a result of which an even greater distance region can be measured. In particular, small distances in front of the scanning device can be measured precisely.

In accordance with a further embodiment of the scanning method, the light beam distance from the laser at which the beam radius of the light beam emitted by the laser is at a minimum is set such that a signal-to-noise ratio of the light beam reflected by the object is minimized. It is thus possible to measure an object precisely and with as small an error as possible.

In accordance with a further embodiment of the scanning method, the light beam distance from the laser at which the beam radius of the light beam emitted by the laser is at a minimum is set to an object distance of the object from the laser. As a result, the resolution of the laser at the position of the object is the greatest.

In accordance with a further embodiment of the scanning method, before the detection of whether an object is situated within a capturable distance region from a laser, a check is carried out as to whether it is possible, by way of setting the focal length of the collimator lens to a particular fixed focal value, for the beam radius of the light beam emitted by the laser for a fixedly specified distance region to be smaller than a specified value; and the focal length of the collimator lens is set to this fixed focal value and a micromirror is activated, if this is the case, or the value of the focal length of the collimator lens is continuously varied and the micromirror is activated, if this is not the case; and the fixedly specified distance region is scanned using the activated micromirror and by setting the focal length of the collimator lens; and, after the detection as to whether an object is situated within a capturable distance region from a laser, the object is tracked; and the scanning method is repeated if the object is no longer detected. It is hereby possible to automatically track an object and to bring the object into focus.

In accordance with a further embodiment of the scanning method, a distance, a velocity or an angular displacement of the object is measured. In particular, the measurement can be performed within a large measurement region.

### BRIEF DESCRIPTION OF THE DRAWINGS

In the figures:

FIG. 1 shows a side view of an exemplary scanning device;

FIG. 2 shows a diagram for explaining a connection between the light beam distance and the beam radius;

FIG. 3 shows a plan view of a scanning area;

FIGS. 4a, b show side views of a scanning device in accordance with a first embodiment of the invention;

FIGS. 5a, b, c show diagrams for explaining a connection between the light beam distance and the beam radius in dependence on the focal length of the collimator lens in accordance with the first embodiment of the invention;

FIG. 6 shows a diagram of a relationship between a minimum light beam distance and the focal length of the collimator lens in accordance with the first embodiment of the invention;

FIG. 7 shows a side view of a scanning device in accordance with a further embodiment of the invention;

FIG. 8 shows a side view of an exemplary scanning device;

FIG. 9 shows a plan view of a scanning area;

FIG. 10 shows a side view of a scanning device in accordance with a further embodiment of the invention; and

FIGS. 11, 12 show flowcharts for explaining scanning methods in accordance with different embodiments of the invention.

In all figures, identical or functionally identical elements and devices are provided with the same reference signs, unless indicated otherwise. The numbering of method steps serves for clarity and in particular is not to imply any specific time sequence, unless indicated otherwise. In particular, it is also possible for a plurality of method steps to be performed at the same time.

### DESCRIPTION OF THE EXEMPLARY EMBODIMENTS

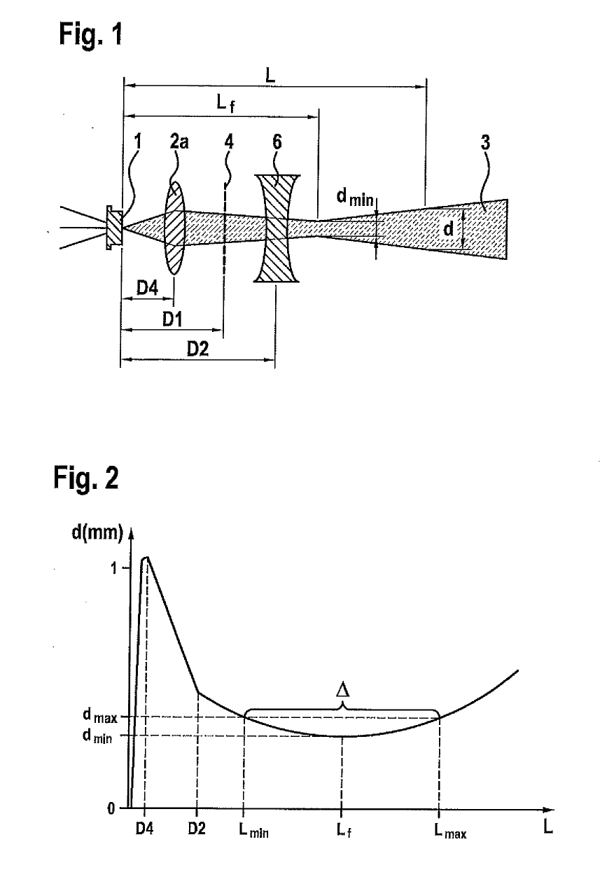

FIG. 1 shows an exemplary scanning device. The scanning device has a laser 1. Situated at a distance D4 from the laser 1 is a collimator lens 2a, which is configured to focus a light beam 3 emitted by the laser 1. A lens axis of the collimator lens 2a is here perpendicular to the emission direction of the light beam 3. Light beam 3 can be described as a Gaussian beam and has, at a light beam distance L from the laser 1, a beam radius d that depends on the light beam distance L.

Situated at a distance D1 from the laser 1 in the light path of the light beam 3 downstream of the collimator lens 2a is a micromirror 4, which is configured to modulate the light beam 3. It is possible by deflecting the micromirror 4 to deflect the light beam 3 in a plane perpendicular to the emission direction.

Situated at a distance D2 from the laser 1 in the light path of the light beam 3 downstream of the micromirror 4 is a magnification lens 6. A lens axis of the magnification lens 6 is here parallel with respect to the lens axis of the collimator lens 2a.

The beam radius d of the light beam 3 for a light beam distance L equal to a specific optimum light beam distance L_{f} becomes minimum and is identical to a beam waist dₘᵢₙ. The optimum light beam distance L_{f} is here dependent on a focal length f1 of the collimator lens 2a and a focal length f2 of the magnification lens 6.

FIG. 2 shows a diagram for explaining a relationship between the light beam distance L of the light beam 3 and the beam radius d of the light beam 3. The beam radius d of the light beam 3 increases up to a distance D4 at which the collimator lens 2a is located, then decreases up to distance D2 at which the magnification lens 6 is located, further decreases up to the optimum light beam distance L_{f} and increases for greater light beam distances L. The magnification lens in particular ensures that a scanning angle of the light beam upstream of the micromirror increases.

When the scanning device is used, the resolution of the light signals, which can be evaluated by a capture unit (not shown), is limited such that the scanning device can be used only in a region in which the beam radius d is smaller than a specified maximum beam radius dₘₐₓ. The value of the maximum beam radius dₘₐₓ is dependent on the scanning device here and can be, for example, 0.1, 0.5 mm or 1 mm.

As FIG. 2 shows, there are two values of the light beam distance L for which the beam radius d is equal to the maximum beam radius dₘₐₓ, a minimum light beam distance Lₘᵢₙ and a maximum light beam distance Lₘₐₓ, with Lₘₐₓ>Lₘᵢₙ. For this reason, the beam radius d is smaller in the light beam distance region having a breadth Δ=Lₘₐₓ−Lₘᵢₙ, in which the light beam distance L meets the condition Lₘᵢₙ<L<Lₘₐₓ, than the maximum beam radius dₘₐₓ, and the scanning device can be used for scanning.

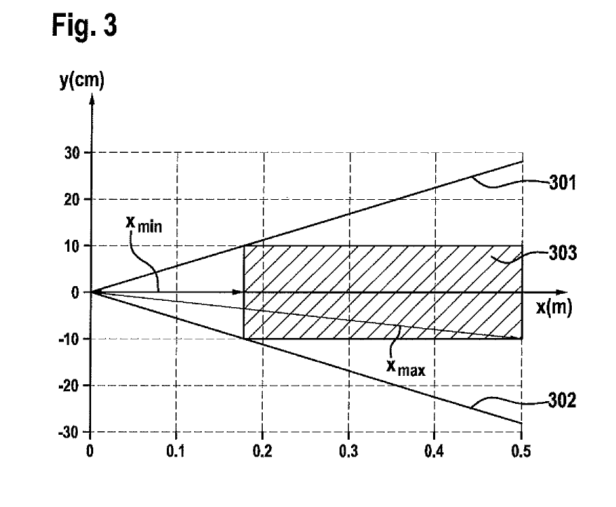

FIG. 3 shows an exemplary plan view of a two-dimensional scanning area which is being scanned. The x-axis here corresponds to the emission direction of the light beam 3, with the x-coordinate corresponding to a magnification lens light beam distance x=L−D2 of the light beam 3 from the magnification lens 6. The micromirror 4 is deflected in the xy-plane, wherein an angle that is enclosed by the mirror axis of the micromirror 4 with the x-axis is periodically varied between 90°+Δα and 90°−Δα, with Δα being a specified value, for example 10°, 20°, 30° or 45°. As a result, the light beam 3 is periodically varied within a triangular space between a first half-line 301 and a second half-line 302, which are symmetric with respect to the x-axis. Since, as described above, only a light beam distance L between the minimum light beam distance Lₘᵢₙ and the maximum light beam distance Lₘₐₓ is measurable, a rectangular area 303 is defined thereby, which is situated completely within the triangular space defined by the half-line 301 and the half-line 302. The rectangular region 303 here has a minimum distance xₘᵢₙ from the coordinate origin with the value Lₘᵢₙ−D2 along the x-axis, and a maximum distance xₘₐₓ from the coordinate origin with the value Lmax−D2 to an outer corner of the rectangular area 303. The rectangular area 303 corresponds to a scannable region. By setting the focal length f2 of the magnification lens 6, a breadth in the y-direction of the rectangular area 303 and thus also a total area of the scannable region can be enlarged. The breadth of the rectangular area 303 in the y-direction is referred to as the scanning range.

The magnification lens 6 thus increases the scanning range of the scanning device, which is oriented in the xy-plane. The magnification lens 6 has a magnification M. As a result, a scanning deflection +/−Δα without a magnification lens 6 is increased to a value +/−M·Δα by inserting the magnification lens having a magnification M.

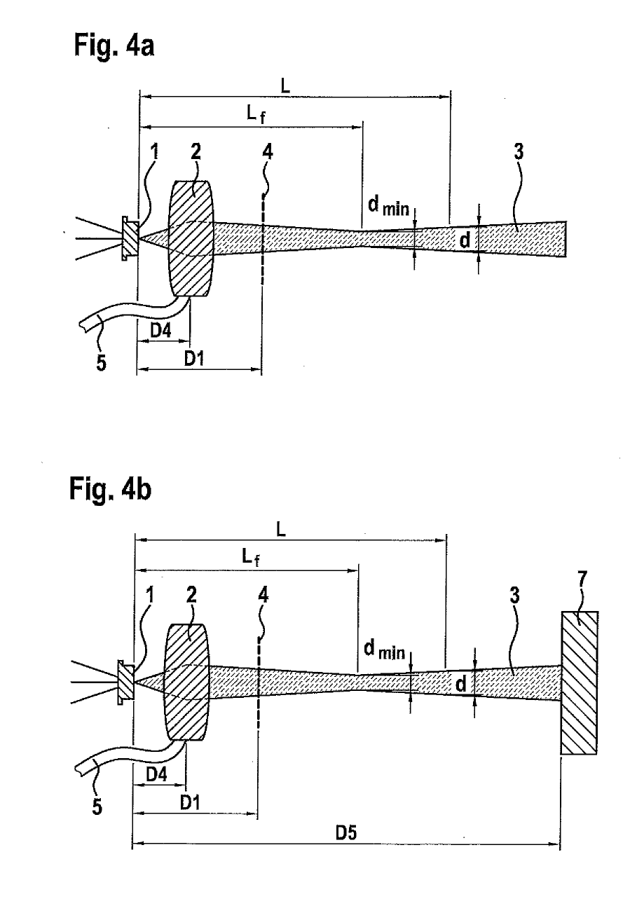

FIG. 4a shows a scanning device in accordance with a first embodiment of the present invention. The scanning device has a laser 1, which can be in particular a vertical cavity surface emitting laser (VCSEL). Situated at a distance D4 from the laser 1 is a collimator lens 2, which is configured to focus a light beam 3 emitted by the laser 1. A lens axis of the collimator lens 2 is here perpendicular to the light beam 3. The collimator lens 2 is here a lens having a settable focal length f1. The collimator lens 2 can be connected, via a connection 5, to a controller (not shown), which is configured to adjust the focal length f1 of the collimator lens 2. The collimator lens 2 can here comprise for example a liquid-crystal lens, an optofluidic lens, a polymer lens or a mechanically settable lens. The collimator lens 2 can be based, for example, on MEMS technology, as a result of which in particular fast reaction times for setting the focal length f1 of the collimator lens 2 in the order of magnitude of milliseconds can be achieved.

Situated at a distance D1 from the laser 1 in the light path of the light beam 3 downstream of the collimator lens 2a is a micromirror 4, which is configured to modulate the light beam 3. The micromirror 4 can be, for example, a microscanner or a micro-oscillation mirror. By deflecting the micromirror 4 it is possible to deflect the light beam 3 in a plane perpendicular to the emission direction of the light beam 3. The micromirror 4 can be controlled for example in accordance with an electromagnetic, electrostatic, thermoelectric or piezoelectric functional principle.

The light beam 3 can be described, analogously to the scanning device described in FIG. 1, as a Gaussian beam and has at a light beam distance L from the laser 1 a beam radius d that is dependent on said light beam distance L. The beam radius d of the light beam 3 for a light beam distance L equal to a specific optimum light beam distance L_{f} becomes minimum and is equal to a beam waist dₘᵢₙ. The optimum light beam distance L_{f} is here dependent on the focal length f1 of the collimator lens 2a and on the distance D4 of the laser from the collimator lens 2a. It is possible in particular by varying the focal length f1 of the collimator lens 2 to vary the optimum light beam distance L_{f}.

In FIG. 4b, an object 7 is moreover located in a beam path of the light beam 3. By measuring the interference between the light beam 3 emitted by the laser and the light beam 3 reflected by the object 7, it is possible to measure a distance, a velocity and/or an angular displacement of the object 7. The angular displacement of the object 7 can be determined in particular on the basis of a deflection of the micromirror. The position of the object 7 can thus be determined by way of the micromirror position.

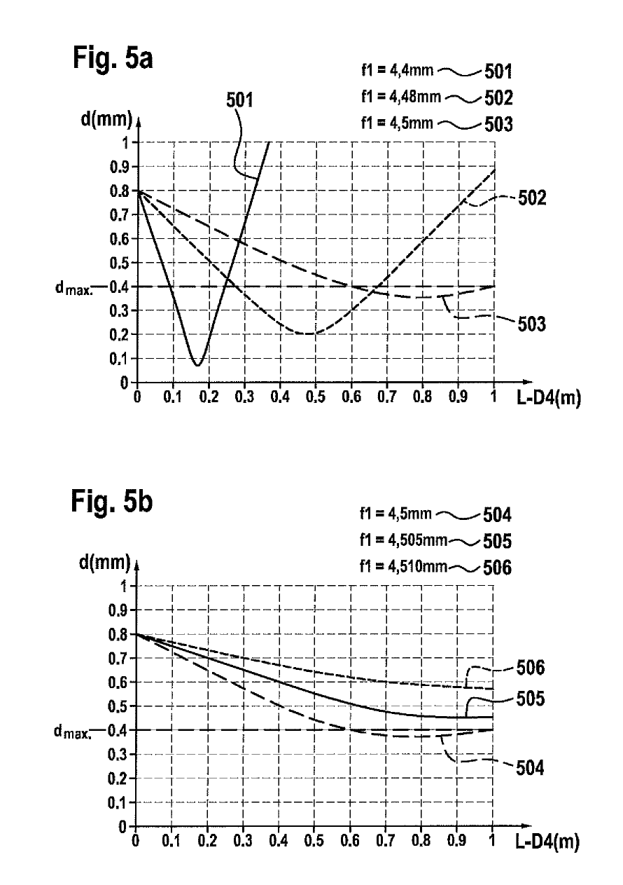

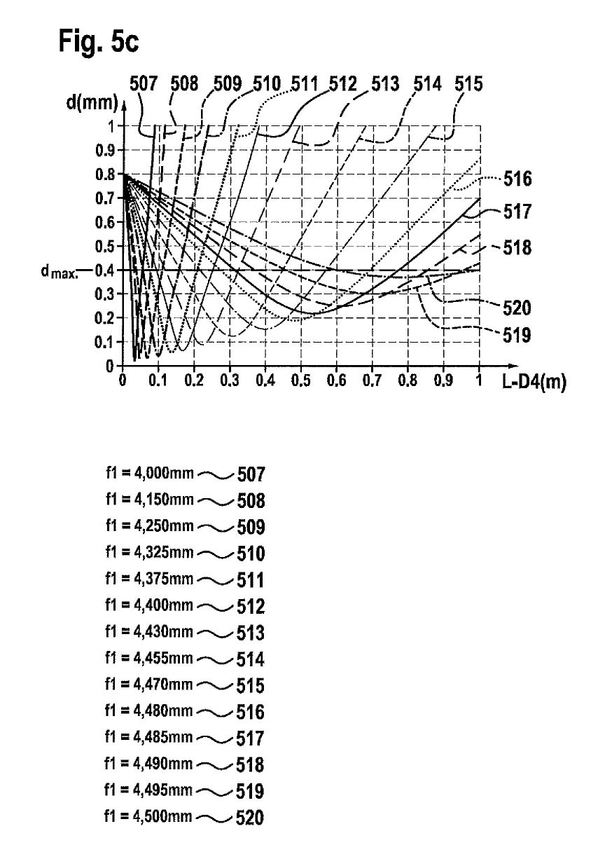

FIGS. 5a, b, c show exemplary diagrams for explaining a relationship between the light beam distance L and the beam radius d of the light beam 3 in dependence on the focal length f1 of the collimator lens 2 in accordance with the first embodiment of the invention. FIG. 5a shows the beam radius d as a function of the distance L−D4 of the light beam from the micromirror 4. A curve 501 here corresponds to a focal length f1 of the collimator lens 2 equal to 4.4 mm, a curve 502 corresponds to a focal length f1 of the collimator lens 2 equal to 4.48 mm, and a curve 503 corresponds to a focal length f1 of the collimator lens 2 equal to 4.5 mm.

In FIG. 5b, a curve 504 here corresponds to a focal length f1 of the collimator lens 2 equal to 4.5 mm, a curve 505 corresponds to a focal length f1 of the collimator lens 2 equal to 4.05 mm, and a curve 506 corresponds to a focal length f1 of the collimator lens 2 equal to 4.51 mm.

In FIG. 5c, a curve 507 here corresponds to a focal length f1 of the collimator lens 2 equal to 4.0 mm, a curve 508 corresponds to a focal length f1 of the collimator lens 2 equal to 4.15 mm, a curve 509 corresponds to a focal length f1 of the collimator lens 2 equal to 4.25 mm, a curve 510 corresponds to a focal length f1 of the collimator lens 2 equal to 4.325 mm, a curve 511 corresponds to a focal length f1 of the collimator lens 2 equal to 4.375 mm, a curve 512 corresponds to a focal length f1 of the collimator lens 2 equal to 4.4 mm, a curve 513 corresponds to a focal length f1 of the collimator lens 2 equal to 4.43 mm, a curve 514 corresponds to a focal length f1 of the collimator lens 2 equal to 4.455 mm, a curve 515 corresponds to a focal length f1 of the collimator lens 2 equal to 4.47 mm, a curve 516 corresponds to a focal length f1 of the collimator lens 2 equal to 4.48 mm, a curve 517 corresponds to a focal length f1 of the collimator lens 2 equal to 4.485 mm, a curve 518 corresponds to a focal length f1 of the collimator lens 2 equal to 4.49 mm, a curve 519 corresponds to a focal length f1 of the collimator lens 2 equal to 4.495 mm, and a curve 520 corresponds to a focal length f1 of the collimator lens 2 equal to 4.5 mm.

As can be seen from FIGS. 5a, b and c, the measurable region, i.e. the region in which the beam radius d is smaller than the maximum beam radius dₘₐₓ, for larger values of the focal width f1 of the collimator lens 2 is displaced toward higher values of the distance L−D4 of the light beam 3 from the micromirror 4, until the measurable region ultimately disappears.

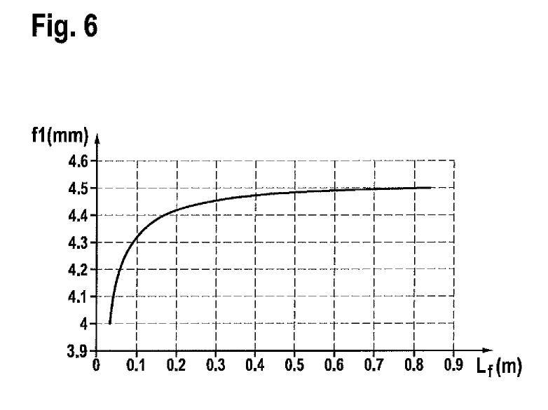

FIG. 6 shows a diagram for explaining a relationship between the optimum light beam distance L_{f} and the focal length f1 of the collimator lens 2. It should be noted here that the optimum light beam distance L_{f} increases exponentially with the focal length f1 of the collimator lens 2.

All number values given in FIGS. 5a, b, c and FIG. 6 merely serve explanatory purposes and are only used as examples.

The focal length of the collimator lens 4 in a specific region is settable between a maximum focal length f1ₘₐₓ and a minimum focal length f1ₘᵢₙ. In a specific application, for example during scanning of a space, typically a maximum measurement distance Lₘₑₛₛ, should still be measurable. The collimator lens 4 is preferably selected such that the optimum light beam distance L_{f} corresponding to the maximum focal length f1ₘₐₓ is greater than the maximum measurement distance Lₘₑₛₛ, such that it is ensured that the maximum measurement distance Lₘₑₛₛ, is still measurable.

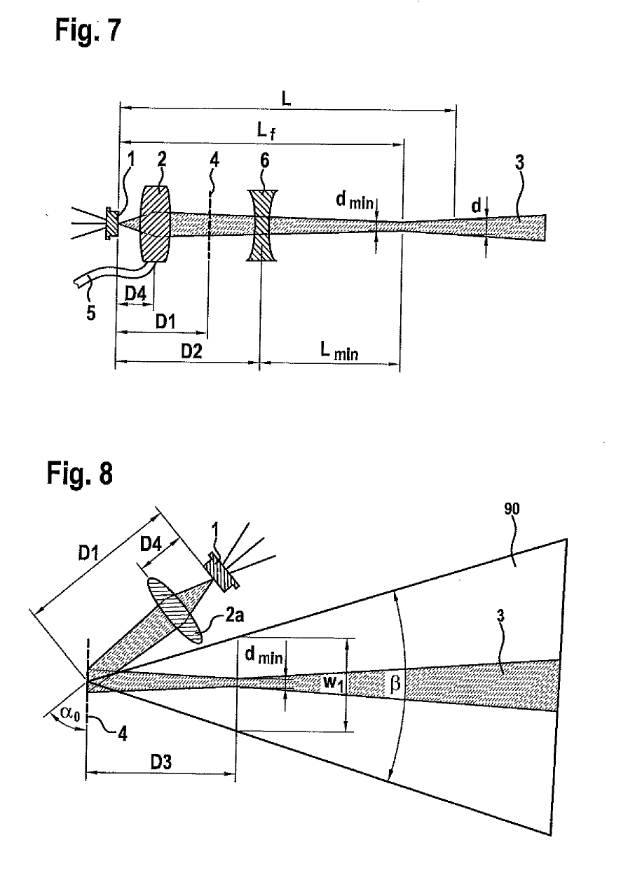

FIG. 7 shows a further embodiment of the present invention, which represents a further development of the embodiment shown in FIG. 4a. Here, additionally located at a distance D2 from the laser 1 in the light path of the light beam 3 downstream of the micromirror 4 is a magnification lens 6. The magnification lens 6 has a magnification M. The beam waist dₘᵢₙ shows the following dependence:

dₘᵢₙ˜λ·M·L_{f}/D.

D is here an opening width of a stop of the micromirror 4, and λ is a wavelength of the light beam 3 emitted by the laser 1. The beam waist dₘᵢₙ thus increases proportionally with respect to the magnification M. By adapting a deformation of the beam upstream of the magnification lens 6, a widening of the focal length can be limited. In this case, the focal length f1 of the collimator lens 2 and the focal length f2 of the magnification lens 6 are adapted.

By deflecting the light beam 3 using the micromirror 4 and the magnification lens 6, optical aberrations occur. The aberrations, in particular spherical aberrations, can preferably be compensated for by adjusting the focal length f1 of the collimator lens 2. Here, in a first control loop, an object is tracked in a region to be scanned. In a second control loop, a value of the focal length f1 of the collimator lens 2 for a position in which the micromirror 4 is parallel with respect to the collimator lens 2 is set. If the micromirror 4 is deflected from this position, i.e. if the micromirror 4 is no longer parallel with respect to the collimator lens 2, then the focal length f1 of the collimator lens 2 is set accordingly.

FIG. 8 shows a side view of an exemplary scanning device. Here, a collimator lens 2a is located at a distance D4 downstream of a laser 1 in the beam path of a light beam 3 emitted by the laser 1, wherein the collimator lens 2a has a fixed, non-settable focal length f1. Located at a distance D1 downstream of the laser 1 is a micromirror 4. The mirror axis of the micromirror 4 here has an angle α₀<90° with the emission direction of the light beam 3, for example α₀ is equal to 20°, 45° or 60°. The angle can here be varied between a minimum value α₀−Δα and a maximum value α₀+Δα, wherein Δα is an angle variation, for example Δα is equal to 10° or 15°. The light beam 3 is reflected at the micromirror 4, and the light beam 3 sweeps over a surface 90 by varying the angle α₀, which surface has an opening angle β. The light beam 3 can be described as a Gaussian beam and has a beam waist dₘᵢₙ at a distance D3 from the micromirror 4. The width of the surface 90 at the distance D3 is here equal to a minimum width w1. It is clear here that in particular for small distances D3 of the beam waist dₘᵢₙ from the micromirror 4 the width w1 becomes small.

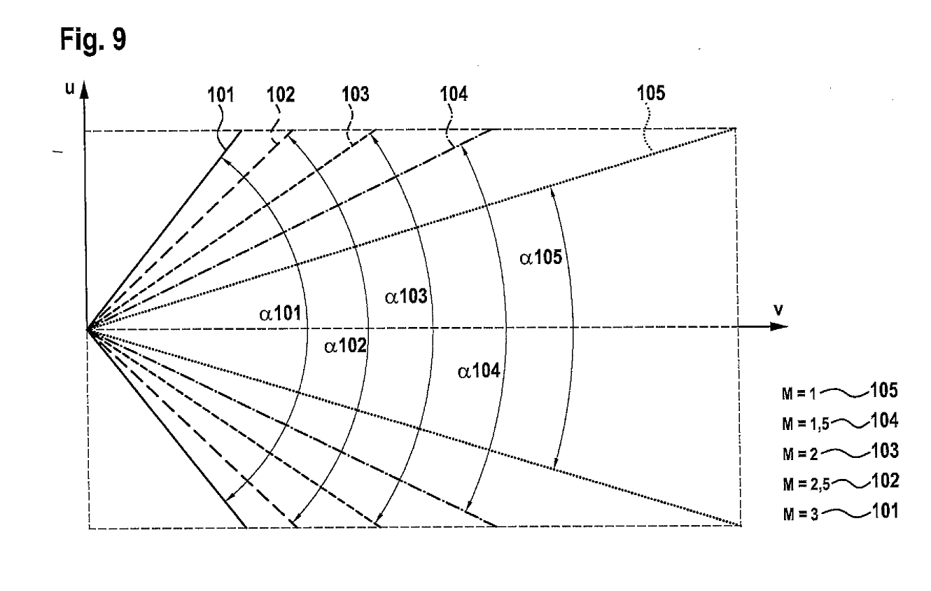

FIG. 9 shows a plan view of a scanning area, wherein here additionally a magnification lens 6 having a magnification M is used in the beam path downstream of the micromirror 4. A v-axis here corresponds to a direction perpendicular to the magnification lens 6, wherein in the magnification lens, v=0. A u-axis corresponds to a lens axis of the magnification lens. Shown here are the scanning area 101 for a magnification M=3 with an opening angle α101, a scanning area 102 for a magnification M=2.5 with an opening angle α102, a scanning area 103 for a magnification M=2 with an opening angle α103, a scanning area 104 for a magnification M=1.5 with an opening angle α104 and a scanning area 105 for a magnification M=1 with a scan angle α105. It is clear that the opening angle increases with the magnification. By increasing the magnification M it is therefore possible to increase a width of the scanning area, as shown in FIG. 8.

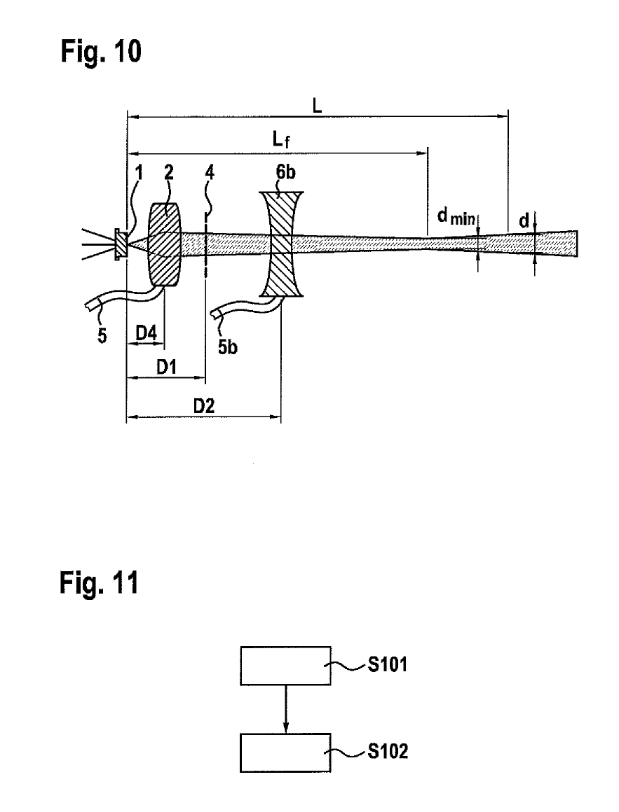

FIG. 10 shows a further embodiment of the present invention. By contrast to the scanning device shown in FIG. 7, the magnification lens 6 is here replaced by a magnification lens 6b with a settable focal length f2. The magnification lens 6b is connected via a connection 5b to a control device (not illustrated), by way of which the focal length f2 of the magnification lens 6b and thus a magnification M of the magnification lens 6b can be set. The magnification lens 6b having a settable focal length f2 can here comprise in particular a liquid-crystal lens, an optofluidic lens, a polymer lens or a mechanically settable lens. When using the scanning device for scanning a specified space, first the focal length f2 of the magnification lens 6b is set for small distances such that the magnification M of the magnification lens 6b is large, for example M=2 or M=3. The exact value of the magnification M of the magnification lens 6b here depends on the measurement distance of the object to be scanned. In a second step, the focal length f1 of the collimator lens 2 is set such that the beam radius d of the light beam 3 at a desired distance is minimum. Conversely, for a large distance of an object to be measured, the magnification M of the magnification lens 6 is set to be small, for example M=1 or M=1.5. In a second step, the focal length f1 of the collimator lens 2 is set such that the beam radius d of the light beam 3 at the desired distance of the object to be scanned is minimum. This ensures that the measurement width remains large for any measurement distance.

FIG. 11 shows a scanning method according to the present invention. Here, in a first step S101, it is detected whether an object 7 is located within a capturable distance region from a laser 1, in particular a VCSEL. A capturable distance region is here the region in which a beam radius d of a light beam 3, which is emitted by the laser 1 and is considered to be a Gaussian beam, is less than a maximum beam radius dₘₐₓ, which is dependent on a resolution of a measurement apparatus used. Detection as to whether an object 7 is located within the capturable distance region is preferably effected by measuring the light beam 3 reflected by the object 7.

If an object 7 was detected, then, in a second step S102, a light beam distance L from the laser 1, i.e. the distance of the emitted light beam 3 from the laser 1 at which the beam radius d of the light beam emitted by the laser 1 is minimum, is set by setting a focal length of a collimator lens 2. The collimator lens 2 is here located in the light path of the laser 1 downstream of the laser 1 such that the light beam 3 passes through the collimator lens 2. The collimator lens 2 is here a lens having a settable focal length f1, for example a liquid-crystal lens, an optofluidic lens, a polymer lens or a mechanically settable lens.

According to a further embodiment, the light beam distance L at which the beam radius d of the light beam emitted by the laser 1 is minimum is set such that a signal-to-noise ratio of the light beam 3 reflected by the object 7 is minimized.

In accordance with a further embodiment, the light beam distance L at which the beam radius d of the light beam emitted by the laser 1 is minimum is set to the object distance D5 of the object 7, which is preferably measured by measuring the reflection of the light beam 3 by the object 7.

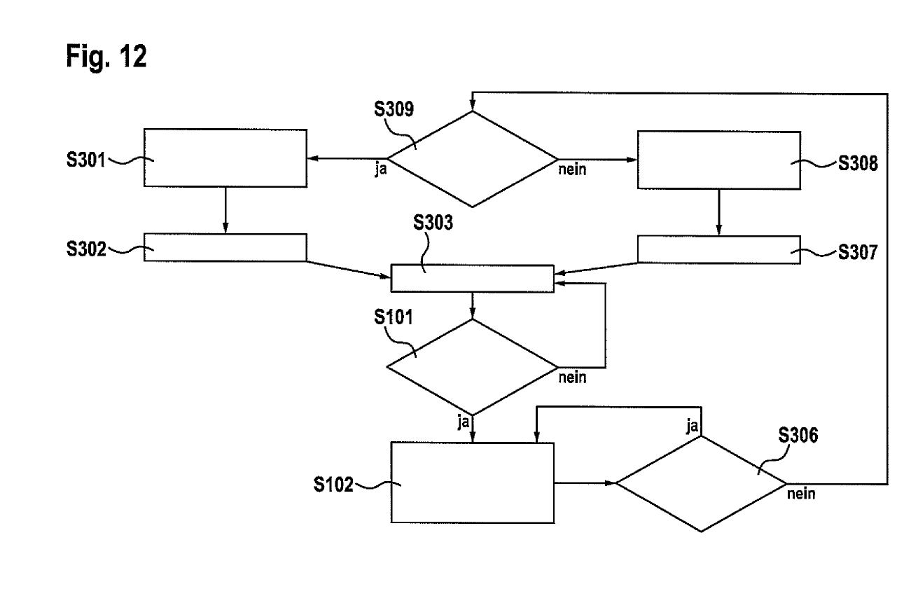

FIG. 12 is a flowchart for explaining a scanning method in accordance with a further embodiment. The scanning method comprises a first step S309 of checking whether it is possible that, by setting the focal length f1 of the collimator lens 2 to a specific fixed focal length, the beam radius d of the light beam 3 for a fixedly specified distance region is smaller than a maximum beam radius dₘₐₓ.

The fixedly specified distance region here corresponds to a distance region in which measurements are intended to be performed and which for this reason should be measurable. In other words, a check is performed as to whether it is possible by setting the focal length f1 to a single fixed focal length to measure the entire specified distance region. This is the case if the beam radius d of the light beam 3 within the entire distance region is smaller than the maximum beam radius dₘₐₓ.

If this is possible, then, in a further step S301, the focal length f1 of the collimator lens 2 is set to this fixed focal length, and the micromirror 4 is activated in a further step S302.

If it is not possible by setting the focal length f1 of the collimator lens 2 to a single fixed focal length to keep the beam radius d of the light beam 3 smaller than the maximum beam radius dₘₐₓ for the fixedly specified distance region, then, in a step S308, the value of the focal length f1 of the collimator lens 2 is continuously varied within a specific value range, and the micromirror 4 is activated in a step S307. The focal length f1 can here be varied in particular in a region between the minimum possible focal length and the maximum possible focal length of the collimator lens 2, wherein a variation time can be, for example, within the range of a few microseconds. However, the invention is not limited hereto, and can in particular be varied within a smaller range.

In both cases, in a further step S303, the fixedly specified distance region is scanned by modulating the light beam 3 by way of the micromirror 4. For example, the micromirror 4 can be deflected in order thus to deflect the light beam 3 and to scan a plane or a volume. Additionally, the focal length f1 of the collimator lens can be varied.

In a step S101, as in the above-mentioned embodiments of the scanning method, it is detected whether an object 7 is located within the capturable distance region.

If an object 7 was detected within the fixedly specified distance region, then, as in the above-mentioned embodiments, in a step S102, a light beam distance L from the laser 1 at which the beam radius d of the light beam emitted by the laser 1 is minimum is set by setting a focal length of a collimator lens 2. In particular, the light beam distance L can be set to the object distance D5, or be set such that a signal-to-noise ratio of the light beam 3 reflected by the object 7 is minimized.

In a step S306, the object is tracked, wherein for example the focal length is set such that at every point in time the signal-to-noise ratio of the light beam reflected by the object 7 is minimized.

If no object is detected anymore, for example because the object is no longer located within the specified distance region or because the object is obscured by a different object, the scanning method can start again with the step of checking S309.

The above embodiments of the scanning method are not limited hereto. In particular, it is also additionally possible for a magnification lens 6 to be arranged in the beam path of the laser 1 downstream of the collimator lens 2 and the micromirror 4.

1. A scanning device, comprising:
a laser for emitting a light beam;
a collimator lens with a settable first focal length for focusing a light beam emitted by the laser; and
a micromirror for modulating the light beam emitted by the laser;
wherein a light beam distance from the laser at which a beam radius of the light beam emitted by the laser is at a minimum is settable by setting the first focal length of the collimator lens.

2. The scanning device as claimed in claim 1, wherein the laser is a VCSEL.

3. The scanning device as claimed in claim 1, wherein the collimator lens comprises a liquid-crystal lens, an optofluidic lens, a polymer lens or a mechanically settable lens.

4. The scanning device as claimed in claim 1 having a magnification lens for magnifying a scanning range of a region scanned by the laser.

5. The scanning device as claimed in claim 4, wherein
the magnification lens has a second settable focal length; and
the magnification of the scanning range of the region scanned by the laser is settable by setting the second focal length of the magnification lens.

6. A scanning method, comprising the following steps:
detecting whether an object is located within a capturable distance region from a laser, in which a beam radius of a light beam emitted by the laser is less than a specified value, on the basis of the light beam reflected by the object; and
setting a light beam distance from the laser at which the beam radius of the light beam emitted by the laser is at a minimum radius by setting a first focal length of a collimator lens, which is arranged downstream of the laser, if an object was detected.

7. The scanning method as claimed in claim 6, wherein the light beam distance from the laser at which the beam radius of the light beam emitted by the laser is the minimum radius is set such that a signal-to-noise ratio of the light beam reflected by the object is minimized.

8. The scanning method as claimed in claim 6, wherein the light beam distance from the laser at which the beam radius of the light beam emitted by the laser is minimum is set to an object distance of the object from the laser.

9. The scanning method as claimed in claim 6, wherein:
before detecting whether an object is located within a capturable distance region from a laser performing a check as to whether it is possible by setting the first focal length of the collimator lens to a pre-determined fixed focal length, for the beam radius of the light beam emitted by the laser for a pre-determined distance region to be smaller than a pre-determined value; and
the first focal length of the collimator lens is set to this fixed focal length and a micromirror is activated if this is the case, or the value of the first focal length of the collimator lens is continuously varied and the micromirror is activated if this is not the case; and
the fixedly specified distance region is scanned by way of the activated micromirror and by setting the first focal length of the collimator lens; and
after the detection as to whether an object is located within a capturable distance region from a laser, the object is tracked; and
the scanning method is repeated if the object is no longer detected.

10. The scanning method as claimed in claim 6, wherein a distance, a velocity or an angular displacement of the object is measured.
